(19) United States
(12) Patent Application Publication
(10) Pub. No.: US 2004/0164931 A1
(43) Pub. Date: Aug. 26, 2004

(54) Plasma display and method of driving the same

(75) Inventors: Jung Gwan Han, Kumi-shi (KR); Seong Won Ji, Chilgok-gun (KR); Beong Ha Lim, Daegu-kwangyeokshi (KR); Yang Keun Lee, Kumi-shi (KR)

Correspondence Address: FLESHNER & KIM, LLP, P.O. BOX 221200, CHANTILLY, VA, 20153, US

(73) Assignee: LG Electronics Inc.

(21) Appl. No.: 10/784,782

(22) Filed: Feb. 24, 2004

(30) Foreign Application Priority Data
Feb. 25, 2003 (KR) P2003-11767

(51) Int. Cl. G09G 3/28

(52) U.S. Cl. 345/60

(57) ABSTRACT

The present invention relates to a plasma display and a driving method thereof adapted for reducing power consumption required for an addressing discharge and decreasing the heat generated in a data driving circuit of the plasma display.

The plasma display includes an initializing driver for initializing cells, an address driver for selecting on-cells by applying data of a first voltage to an address electrode and a scan pulse to a scan electrode and for selecting off-cells by applying data of a third voltage to the address electrode and the scan pulse to the scan electrode, wherein the second voltage is higher than the first voltage.

### BACKGROUND OF THE INVENTION

1. Field of the Invention

The present invention relates to a plasma display, and more particularly to a plasma display and a method thereof capable of reducing power consumption required for an addressing discharge and decreasing the heat generated in a data driving circuit in the plasma display.

2. Description of the Related Art

Generally, a plasma display radiates a phosphorus using an ultraviolet ray with a wavelength of 147 nm generated upon discharge of an inactive mixture gas, such as He+Xe, Ne+Xe or He+Ne+Xe, to thereby display a picture including characters and graphics. Such a plasma display is easy to be made into a thin-film and large-dimension type. Moreover, the plasma display provides an improved picture quality with the aid of a recent technical development. Particularly, since the plasma display using a three-electrode, alternating current (AC) surface-discharge PDP has properties to reduce voltage needed to the discharge using wall charges accumulated on the dielectric surface thereof upon the discharge and to protect electrodes from a sputtering generated by the discharge with dielectric, it has advantages of a low-voltage driving and a long life.

Referring to FIG. 1, in a related art of the three-electrode, alternating current (AC) surface-discharge PDP, n-number of scan electrodes Y1 to Yn and n-number of common sustain electrodes Z are intersected to m-number of address electrodes X1 to Xm with an electrode therebetween wherein m×n-number of cells 1 are located in the intersection. A barrier rib 2 is formed between adjacent address electrodes X1 to Xm in order to intercept electrical and optical interference caused among the horizontally adjacent cells 1.

The scan electrodes Y1 to Yn select scan lines when scan signals are sequentially applied thereto and occur a sustain discharge for the selected cells when sustain pulses are applied thereto. The common sustain electrodes Z occur the sustain discharge for the cells selected by the sustain pulses and their alternating sustain pulses supplied to the scan electrodes Y1 to Yn. The address electrode X1 to Xm select cells 1 in response to data pulses synchronized with the scan signals.

In order to express gray levels of a picture, the plasma display is driven with time division scheme wherein one field period (e.g., NTSC system: 16.67 ms) is divided into a plurality of sub-fields having a different light-emission frequency. Each sub-field includes a reset period to initialize cells of full screen, an address period to select a scan line and in turn a cell in the selected scan line, and a sustain period (or a write period) to express gray levels depending upon a discharge frequency. For instance, when it is intended to display a picture with 256 gray levels, a frame period (i.e., 16.67 ms) corresponding to 1/60 second is divided into eight (8) sub-fields SF1 to SF8 as shown in FIG. 2. As described above, each of the 8 sub-fields SF1 to SF8 is divided again into the reset period, the scan period and the sustain period. Herein, the reset period and the address period of each sub-field are identically repeated for every sub-field, whereas the sustain period is increased at a ratio of 2ⁿ (wherein n=0, 1, 2, 3, 4, 5, 6 and 7) at each sub-field. And in FIG. 2, reference numerals ‘SC1 to SCn’ represents n-number of scan lines formed in the PDP.

FIG. 3 shows a driving signal supplied to the PDP for one sub-field period. FIGS. 4 and 5 illustrate the change of a wall charges when the driving signal as in the FIG. 3 is applied to the PDP, respectively.

Referring to FIGS. 3 to 5, the plasma display is driven by a reset period for initializing entire cells, an address period for selecting a cell, and a sustain period for sustaining a discharge of the selected cell.

In the reset period, a rising ramp waveform Ramp-up is simultaneously applied to all of the scan electrodes Y. At this time, zero(0) V is applied to a sustain electrodes Z and address electrodes X. The rising ramp waveform Ramp-up cause a set-up discharge of a dark discharge type that the light does not almost generate between the scan electrodes Y and the address electrodes X, and at the same time, cause the set-up discharge of the dark discharge type between the scan electrodes Y and the sustain electrodes Z. By this set-up discharge, positive wall charges are accumulated on the address electrodes X and the sustain electrodes Z, and negative wall charges are accumulated on the scan electrodes Y. In this connection, the amount of the negative wall charges accumulated on the scan electrodes Y is equal to that of the positive wall charges accumulated on the address electrodes X and the sustain electrodes Z.

Following the rising ramp waveform Ramp-up, a falling ramp waveform Ramp-down falling from a positive voltage lower than a peak voltage of the rising ramp waveform Ramp-up up to the ground voltage GND or a specific negative voltage level is applied to all of the scan electrodes Y. At the same time, a positive sustain voltage Vs is applied to the sustain electrodes Z, and zero(0) V is applied to the address electrodes X. In this way, when the falling ramp waveform Ramp-down is applied, a set-down discharge of a dark discharge type that the light does nearly generate, is occurred between the scan electrodes Y and the sustain electrodes Z. By the set-down discharge, an excessive wall charge that is unnecessary in an address discharge is erased. As a result of the set-down discharge, there is little the change of the wall charges on an address electrode X, whereas the negative walls charge on the scan electrodes Y are decreased and the positive wall charges accumulated on the sustain electrodes Z are converted into the negative wall charges being accumulated on the sustain electrodes Z by the amount of the decrease of the negative wall charges on a scan electrode Y.

In the address period, zero(0) V or a negative scan pulse SCN of a negative scan voltage −Vy is sequentially applied to the scan electrodes Y and, at the same time, a positive data pulse DATA of a data voltage Vd is applied to the address electrodes X. A voltage difference between the scan pulse SCN and the data pulse DATA is added to the wall voltage generated in the reset period to thereby cause an address discharge, as shown in the FIG. 4 within an on-cell supplied with the data pulse DATA. The wall charges enough to occur the discharge when the sustain voltage Vs is applied are formed within on-cells selected by the address discharge. At this time, the positive wall charges are accumulated on the scan electrodes Y and the negative wall charges are accumulated on the address electrodes X by the address discharge. On the other hand, as shown in the FIG. 5, the address discharge does not occur in an off-cell under the condition that not data voltage Vd but zero(0) V is applied to the address electrode X or that not the scan pulse SCN but a scan bias voltage Vscb is applied to the scan electrodes Y because the sum of a wall voltage created in the reset period and an external voltage is lower than a firing voltage (which cause to occur discharge between cells). Thus, in the off cell, the wall charges are still maintained in the address and the sustain periods after the reset period.

In the sustain period, after a sustain pulse SUS of the sustain voltage Vs is applied to the scan electrodes Y, the sustain pulse SUS is alternately applied to the sustain electrodes Z and the scan electrodes Y. Consequently, a wall voltage within the on-cells selected by the address discharge is added to the sustain voltage Vs, and whenever each sustain pulse SUS is applied thereto, as shown in the FIG. 4, the sustain discharge, that is, a display discharge occurs between the scan electrodes Y and the sustain electrodes Z in the on-cells. On the other hand, the sustain discharge does not occur in non-selected cells that are not selected in the address period because the sum of the wall voltage within the non-selected cells and an external voltage is lower than the firing voltage, as shown in the FIG. 5.

After the completion of the sustain discharge, an erasing signal (not shown) for erasing the wall charge remaining within the cells is applied to the scan electrodes Y or the sustain electrodes Z.

In this manner, in the related art of the plasma display, a high data voltage Vd should be applied to the address electrodes X in order to select the on-cells in the address period, which leads to flow an excessive current between the address electrodes X and the scan electrodes Y due to the address discharge occuring in the on-cells. Owing to this, the related art plasma display has drawbacks that power consumption is increased and the heat generated in data driving integrated circuit IC for driving the address electrodes X becomes higher.

### SUMMARY OF THE INVENTION

Accordingly, it is an object of the present invention to provide a plasma display and a driving method thereof adapted for decreasing power consumption required for an address discharge and reducing the heat generated in a data driving circuit of the plasma display.

In order to achieve these and other objects of the invention, an apparatus of a plasma display according to one aspect of the present invention includes a initializing driver for initializing the cell; an address driver for selecting on-cell by applying data of a first voltage to the address electrode and a scan pulse of a second voltage to the scan electrode, and for selecting off-cell by applying data of a third voltage and the scan pulse to the cells when the third voltage is higher than the first voltage.

The initializing driver supplies an identical waveform to both of the scan electrode and the sustain electrode.

The initializing driver simultaneously supplies a rising ramp waveform and a falling ramp waveform following the rising ramp waveform to the scan electrode and the sustain electrode.

The initializing driver supplies the falling ramp waveform and a rising ramp waveform following the falling ramp waveform to the scan electrode, and supplies a fourth negative voltage to the sustain electrode.

The plasma display further includes a sustain driver for supplying the fourth voltage to the sustain electrode in the address period to select the on-cells and the off-cells.

The falling ramp waveform falls from a first negative voltage to a second negative voltage, the absolute value of the second negative voltage being higher than that of the first negative voltage; and

The rising ramp waveform rises from the first negative voltage to zero(0)V.

The first voltage to select the on-cells is any one of zero(0)V and the ground voltage GND

The second voltage is a positive voltage.

The plasma display further includes a sustain driver for applying alternately a sustain pulse of a fifth voltage to the scan electrode and the sustain electrode to occur a sustain discharge with respect to the on-cells.

A method of driving a plasma display according to the present invent includes comprising: initializing the cells; selecting on-cells by applying data of a first voltage to the address electrode and a scan pulse of a second voltage to the scan electrode; and selecting off-cells by applying data of a third voltage to the address electrode and the second voltage is higher than the first voltage and the scan pulse to the scan electrode.

A method of driving a plasma display according to the present invent includes a reset period for initializing cells; an address period for selecting the cells using a scan voltage of a first polarity and a data voltage of a second polarity; and a sustain period for maintaining a discharge of the cells using the sustain voltage of the first polarity.

The cells are initialized by an initializing voltage of the first polarity in the reset period.

### BRIEF DESCRIPTION OF THE DRAWINGS

These and other objects of the invention will be apparent from the following detailed description of the embodiments of the present invention with reference to the accompanying drawings, in which:

FIG. 1 is a schematic plane view of a related art of a plasma display;

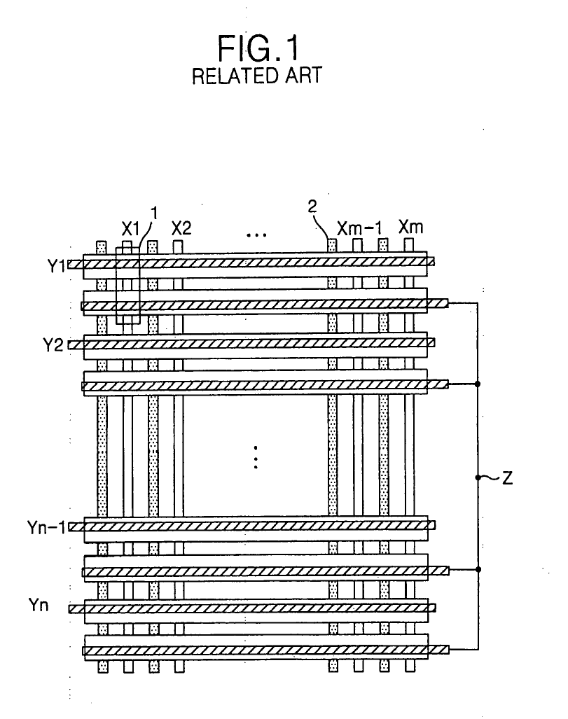

FIG. 2 is a configuration of a frame for explaining a driving method of the related art plasma display;

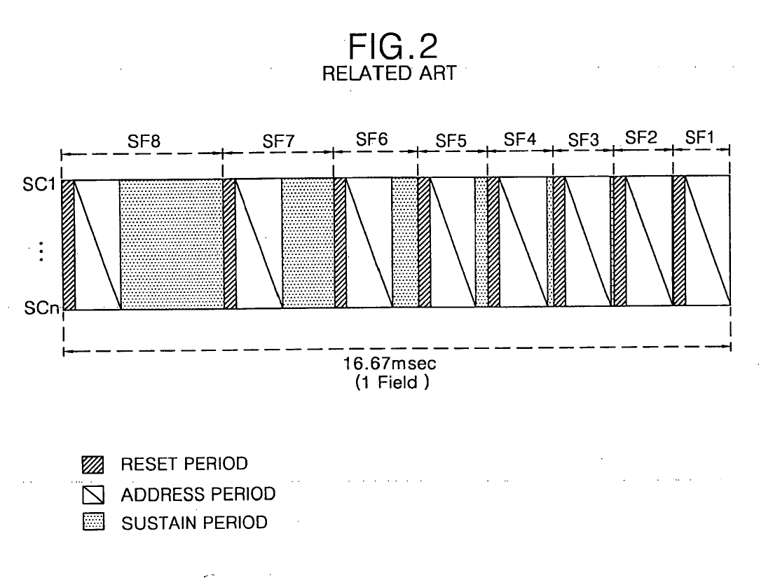

FIG. 3 is a driving waveform used in the related art plasma display;

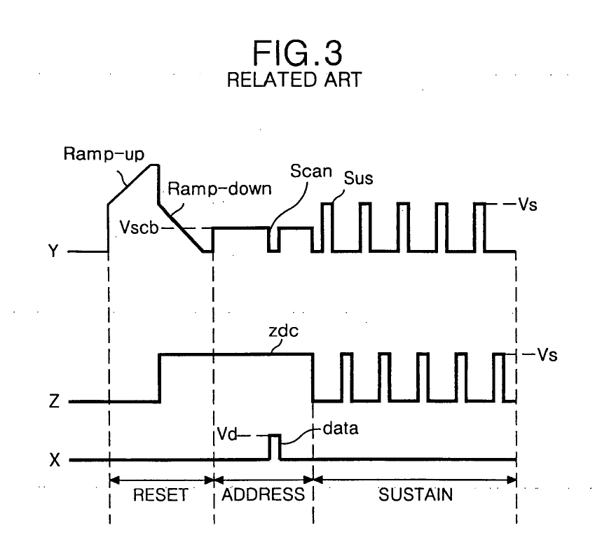

FIG. 4 is a diagram showing the change of a wall charge on an on-cell when the driving waveform as shown in FIG. 3 is supplied to the related art plasma display;

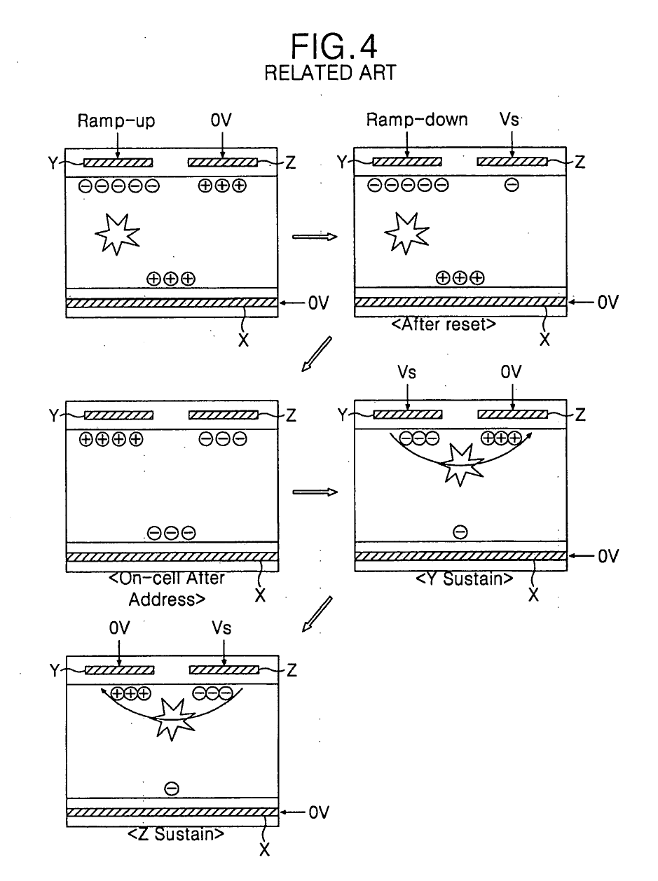

FIG. 5 is a diagram showing the change of a wall charge on an off-cell when the driving waveform as shown in FIG. 3 is supplied to the related art plasma display;

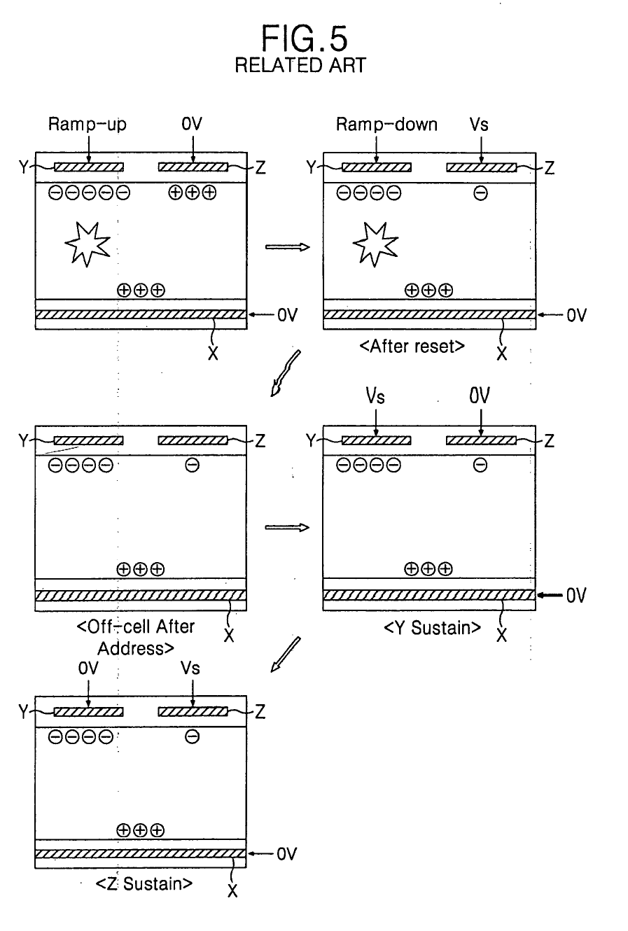

FIG. 6 is a driving waveform for a plasma display according to a first embodiment of the present invention;

FIG. 7 is a diagram showing the change of a wall charge on an on-cell when the driving waveform as shown in FIG. 6 is supplied to the plasma display of the present invention;

FIG. 8 is a diagram showing the change of a wall charge on an off-cell when the driving waveform as shown in FIG. 6 is supplied to the plasma display of the present invention;

FIG. 9 is a driving waveform for a plasma display according to a second embodiment of the present invention;

FIG. 10 is a diagram showing the change of a wall charge on an on-cell when the driving waveform as shown in FIG. 9 is supplied to the plasma display of the present invention;

FIG. 11 is a diagram showing the change of a wall charge on an off-cell when the driving waveform as shown in FIG. 9 is supplied to the plasma display of the present invention; and

FIG. 12 is a schematic block diagram of a plasma display according to the present invention.

### DETAILED DESCRIPTION OF THE PREFERRED EMBODIMENT

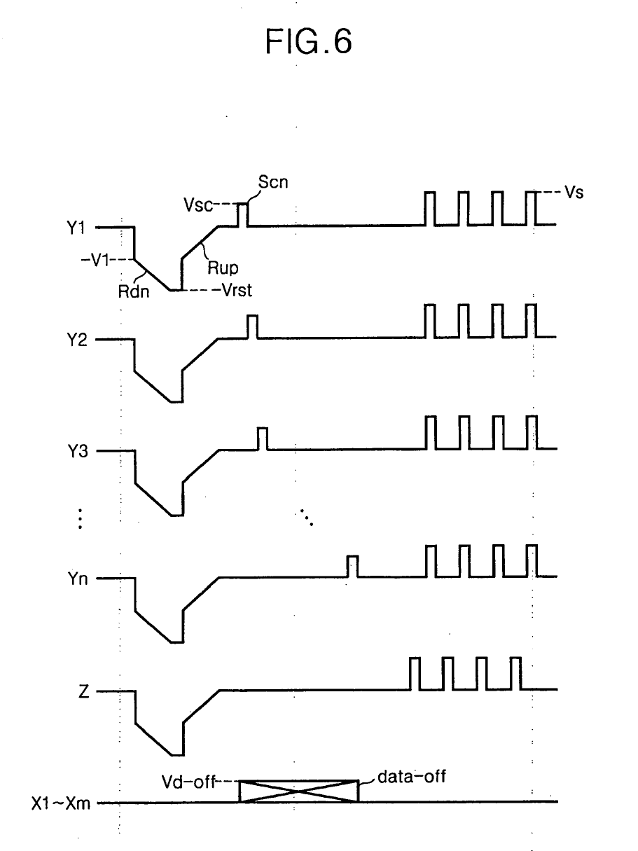

Hereinafter, preferred embodiments of the present invention will be described in detail with reference to FIGS. 6 to 12.

Referring to FIG. 6, there is shown a driving waveform diagram for a plasma display according to a first embodiment of the invention. As shown in FIG. 6, the plasma display is driven in a reset period for initializing all of cells, an address period for selecting a cell and a sustain period for maintaining the discharge of the selected cell.

In the reset period, a falling ramp waveform, Rdn, which is falling from the negative voltage −V1, is simultaneously applied to all of scan electrodes Y1 to Yn and sustain electrodes Z. At the same time, zero(0)V or ground voltage GND is applied to address electrodes X1 to Xm. By the falling ramp waveform Rdn, a set-up discharge is concurrently occurred in a dark discharge type between the scan electrodes Y1 to Yn and the address electrodes X1 to Xm and, between the sustain electrodes Z and the address electrode X1 to Xm within the cells of the full screen. By the set-up discharge, positive wall charges are accumulated on the scan electrodes Y1 to Yn and the sustain electrodes Z, and negative wall charges are accumulated on the address electrodes X.

Following the falling ramp waveform Rdn, a rising ramp waveform Rup, which is rising from −V1 to zero(0) V or the ground voltage GND, is simultaneously applied to both of the scan electrodes Y1 to Yn and the sustain electrodes Z. At this time, the address electrodes X1 to Xm are maintained at zero(0) V or the ground voltage GND. When the rising ramp waveform Rup is applied as set forth above, the set-down discharge is occurred in the dark discharge type between the scan electrodes Y1 to Yn and the address electrodes X1 to Xm, and between the sustain electrodes Z and the address electrodes X1 to Xm. By the set-down discharge, excessive wall charges unnecessary for the address discharge are eliminated. As the result, the wall charges needed for the address discharge are uniformly remained within all of the cells. The distribution of wall charges accumulated when the reset period is ended is as follows. The negative wall charges are remained on the address electrodes X, whereas the positive wall charges are uniformly remained on the scan electrodes Y1 to Yn and the sustain electrodes Z.

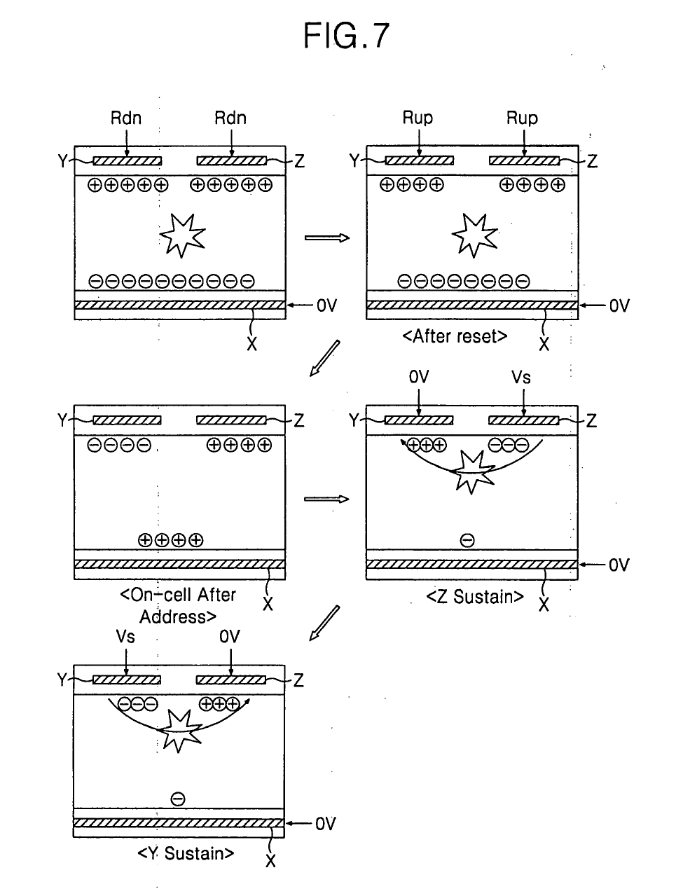

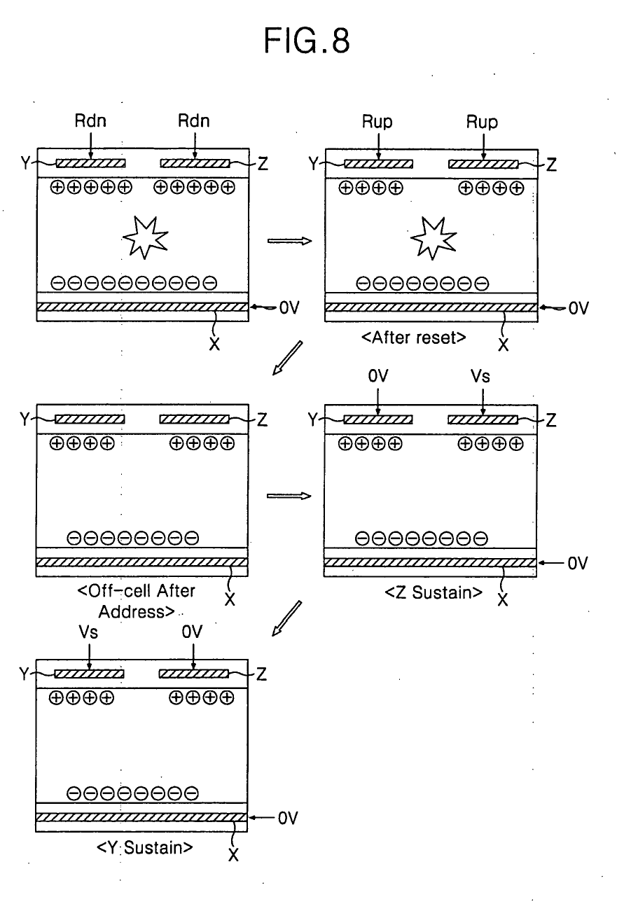

In the address period, a positive scan pulse SCN of a positive scan voltage Vsc is sequentially applied to the scan electrodes Y1 to Yn and, at the same time, a positive data pulse DATA-OFF of a positive Vd-off or zero(0) V (or the ground voltage GND) is applied to the address electrodes X1 to Xm. External voltage is added to the wall charges accumulated on on-cells and then the address discharge is occurred within the on-cells. By the address discharge, when the sustain voltage Vs is applied, the wall charges enough to occur the discharge are formed on the selected cells, as shown in FIG. 7. At this time, the negative wall charges are accumulated on the scan electrodes Y1 to Yn and the positive wall charge are accumulated on the sustain electrodes Z and the address electrodes X by the address discharge. On the other hand, as shown in the FIG. 8, the address discharge does not occur in an off-cell under the condition that the data voltage Vd-off is applied to the address electrode X1 to Xm and the scan pulse SCN is not applied to the scan electrodes Y because the sum of a wall voltage created in the reset period and an external voltage is lower than the firing voltage. Thus, in the off cell, the wall charges are still maintained in the address and the sustain periods after the reset period.

In the sustain period, after a sustain pulse SUS of the sustain voltage Vs is applied to the sustain electrodes Z, the sustain pulse SUS is alternately applied to the scan electrodes Y1 to Yn and the sustain electrodes Z. Thus, a wall voltage within the on-cells selected by the address discharge is added to the sustain voltage Vs and, whenever each sustain pulse SUS is applied, as shown in the FIG. 7, the sustain discharge, that is, a display discharge occurs between the scan electrodes Y1 to Yn and the sustain electrodes Z in the on-cells. On the other hand, the sustain discharge does not occur because the sum of the wall voltage within the non-selected cells and an external voltage is lower than the firing voltage, as shown in the FIG. 8.

After the completion of the sustain discharge, an erasing signal (not shown) for erasing the wall charge remaining within the cells is applied to the scan electrodes Y or the sustain electrodes Z.

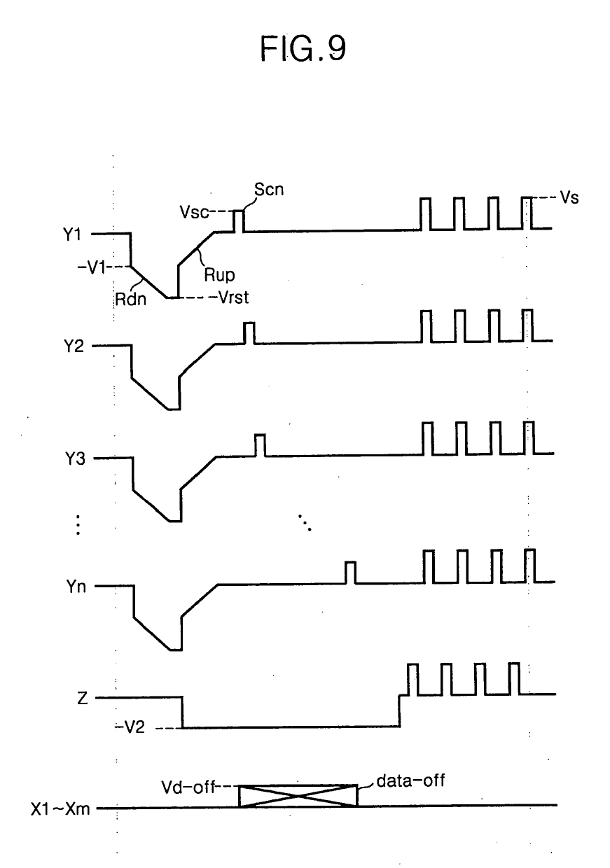

FIGS. 9 to 11 illustrate a driving waveforms and distribution charts of wall charges for explaining a driving method of the plasma display according to a second embodiment of the invention, respectively.

Referring to FIG. 9, the plasma display according to the second embodiment of the invention supplies an initializing voltage of a ramp waveform to the scan electrodes Y1 to Yn and an initializing voltage of a square waveform to the sustain electrodes Z, to thereby initialize cells and to select an on-cell by a low data voltage.

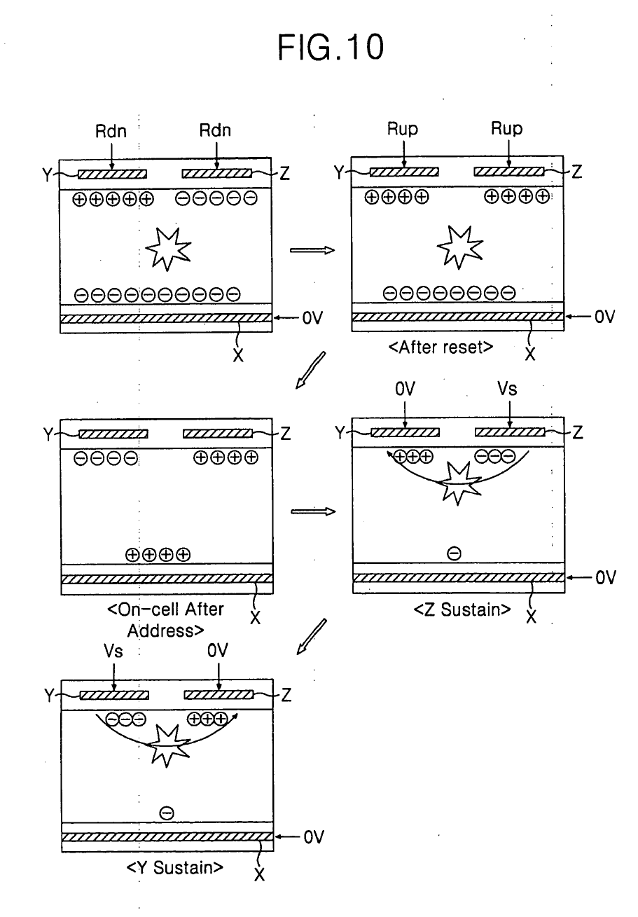

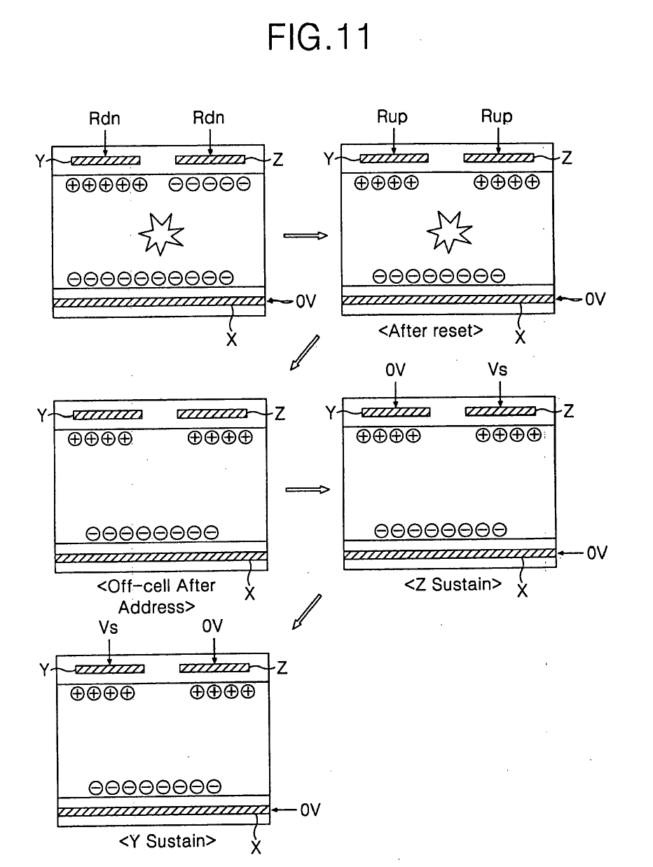

In the reset period, a falling ramp waveform Rdn, which is falling from the negative voltage −V1, is simultaneously applied to all of the scan electrodes Y1 to Yn and the sustain electrodes Z. At the same time, zero(0)V or the ground voltage GND is applied to the address electrodes X1 to Xm. By the falling ramp waveform Rdn, a set-up discharge is concurrently occurred between the scan electrodes Y1 to Yn and the address electrodes X1 to Xn and between the sustain electrodes Z and the address electrode X1 to Xm within the cells of the full screen. By the set-up discharge, positive wall charges are accumulated on the scan electrodes Y1 to Yn a shown in FIGS. 10 and 11, whereas, negative wall charges are accumulated on the address electrodes X and the sustain electrodes Z.

Following the falling ramp waveform Rdn, a rising ramp waveform Rup, which is rising from the voltage −V1 to zero(0) V or the ground voltage GND, is simultaneously applied to the scan electrodes Y1 to Yn and a voltage −V2 of a square waveform is applied to the sustain electrodes Z. The voltage −V2 may be identically or differently set up to the voltage −V1. At this time, the address electrodes X1 to Xm is maintained in zero(0) V or the ground voltage GND. When the rising ramp waveform Rup is applied to the scan electrodes Y and the voltage −V2 as a direct current is applied to the sustain electrodes Z, a set-down discharge is concurrently occurred between the scan electrodes Y1 to Yn and the address electrodes X1 to Xm and between the sustain electrodes Z and the address electrodes X1 to Xm. By the set-down discharge, excessive wall charges unnecessary for the address discharge are erased in all off-cells. As the result, the wall charges needed for the address discharge are uniformly remained within all of the cells. The distribution of the wall charges remaining after the reset period is shown in FIGS. 10 and 11. More specifically, as shown in FIGS. 10 and 11, the negative wall charges are remained on the address electrodes X and the positive wall charges are uniformly remained on the scan electrodes Y1 to Yn and the sustain electrodes Z immediately after the reset period.

In the address period, a positive scan pulse SCN of a positive scan voltage Vsc is sequentially applied to the scan electrodes Y1 to Yn and, at the same time, a positive data pulse DATA-OFF of a positive Vd-off or zero(0) V(or the ground voltage GND) is applied to the address electrodes X1 to Xm. The address discharge is occurred when the external voltage is added to the wall voltage formed in the reset period within on-cells wherein the positive scan pulse SCN and zero(0)V or the ground voltage are applied to the scan electrodes Y1 to Y1. By the address discharge, when the sustain voltage Vs is applied, the wall charges are formed enough to occur the discharge within the selected cells, as shown in FIG. 10. At this time, the negative wall charges are accumulated on the scan electrodes Y1 to Yn and the positive wall charge are accumulated on the sustain electrodes Z and the address electrodes X by the address discharge. On the other hand, as shown in the FIG. 11, the address discharge does not occur in an off-cell under the condition that the data voltage Vd-off is applied to the address electrode X1 to Xm and the scan pulse SCN is not applied to the scan electrodes Y because the sum of a wall voltage created in the reset period and an external voltage is lower than the firing voltage. Thus, in the off cell, the wall charge is still maintained in the address and the sustain periods after the reset period.

In the sustain period, after a sustain pulse SUS of the sustain voltage Vs is applied to the sustain electrodes Z, the sustain pulse SUS is alternately applied to the scan electrodes Y1 to Yn and the sustain electrodes Z. Thus, a wall voltage in the on-cells selected by the address discharge is added to the sustain voltage Vs and whenever each sustain pulse SUS is applied, as shown in the FIG. 10, the sustain discharge, that is, a display discharge occurs between the scan electrodes Y1 to Yn and the sustain electrodes Z in the on-cells. On the other hand, the sustain discharge does not occur in the off-cell because the sum of the wall voltage within the off-cell and an external voltage is lower than the firing voltage, as shown in the FIG. 11.

After the completion of the sustain discharge, an erasing signal (not shown) for erasing the wall charge remaining within the cells is applied to the scan electrodes Y or the sustain electrodes Z.

Consequently, the plasma display and the driving method thereof according to the present invention occurs the address discharge with a low voltage settled as zero(0) V or the ground voltage GND, to thereby select the on-cells, and select the off-cells with the positive voltage.

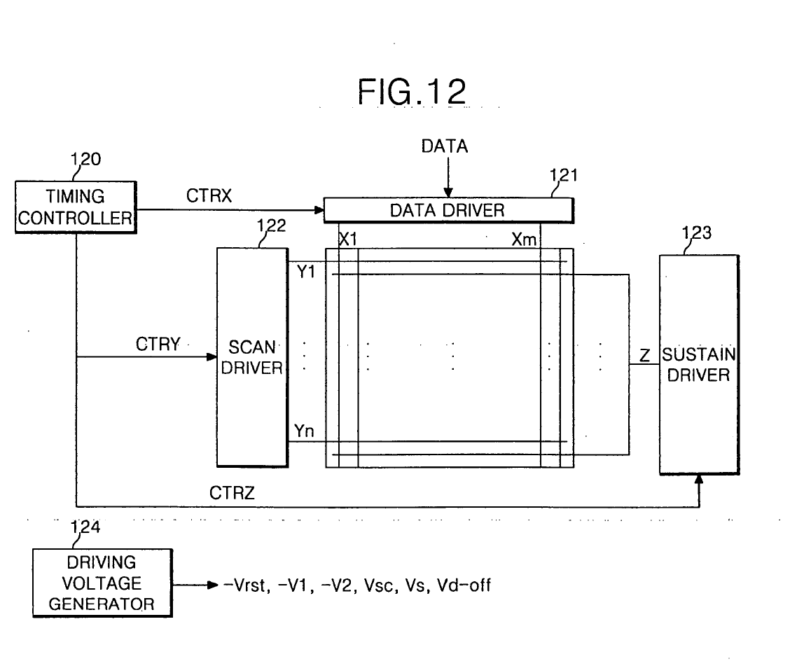

FIG. 12 shows a schematic block diagram showing a plasma display. As shown in FIG. 12, the plasma display includes a data driver 121 connected to the address electrodes X1 to Xm of the PDP, a scan driver 122 connected to the scan electrodes Y1 to Yn of the PDP, a sustain driver 123 connected to the sustain electrodes Z of the PDP, a driving voltage generator 124 for supplying driving voltages necessary for the drivers 121, 122 and 123, and a timing controller 120 for controlling each of the drivers 121,122 and 123.

The data driver 121 is supplied with a data that is subjected to an inverse gamma correction and error diffusion by an inverse gamma correction circuit and an error diffusion circuit (not shown) and then mapped by a sub-field mapping circuit to each sub-field. The data driver 121 samples the data in response to a timing control signal CTRX provided from the timing controller 120. The sampled data is supplied to the address electrodes X1 to Xm by one horizontal line for each one horizontal period. Herein, the timing control signal CTRX provided to the data driver 121 includes a sampling clock for sampling the data, and a switching control signal for controlling on/off switching time of an energy recovery circuit and a switching device. A data voltage supplied from the data driver 121 to the address electrodes X1 to Xm is used to select an off-cell.

The scan driver 122 supplies the falling ramp waveform Ramp-down, as shown in FIGS. 6 and 9, to the scan electrodes Y1 to Yn in the reset period under the control of the timing controller 120 and then supplies the rising ramp waveform Ramp-up to the scan electrodes Y1 to Yn to initialize all cells. Moreover, the scan driver 122 supplies sequentially the positive scan pulse to the scan electrodes Y1 to Yn in the address period under the control of the timing controller 120, and at the same time supplies the sustain pulse to the scan electrodes Y1 to Yn to cause the cells selected by the address discharge to occur the sustain discharge. A timing control signal CTRY applied to the scan driver 122 includes a switching control signal for controlling on/off switching time of switching devices in the scan driver 122.

The sustain driver 123 supplies, under the control of the timing controller 120, in the reset period, an initializing waveform substantially identical to the initializing waveform that from the scan driver 122, that is, a waveform wherein the falling ramp waveform is continued to the rising ramp waveform, as shown in FIG. 6, to the sustain electrodes Z. In the reset period, the sustain driver 123 may supply the voltage −V2 of a square waveform synchronized with the rising ramp waveform supplied to the scan electrodes Y1 to Yn, as shown in FIG. 9, under the timing controller. Further, in the address period, the sustain driver 123 maintains voltage on the sustain electrodes Z as the zero(0) V or the ground voltage GND as shown in FIG. 6 or the voltage on the sustain electrodes Z as the voltage −V2 as shown in FIG. 9. The sustain driver 123 is alternately driven along with the scan driver 122, to supply the sustain pulses as shown in FIGS. 6 and 9 to the sustain electrodes Z. A timing control signal CTRZ applied to the sustain driver 123 includes a switching control signal for controlling on/off switching time of switching devices in the sustain driver 123.

The driving voltage generator 124 includes a current-current converter (DC-DC Converter) for converting a system power from a main board (not shown) to a voltage level of output voltage by using a pulse width modulation system. A driving voltage outputted from the driving voltage generator 124 comprises a negative reset voltage −Vrst corresponding to a lower limit voltage of the falling ramp waveform, a negative voltage −V1 corresponding to a starting voltage of the rising ramp waveform, a direct bias voltage −V2 of the sustain electrode Z, a positive scan voltage Vsc, a sustain voltage Vs and a positive data voltage Vd-off for selecting the off-cells.

The timing controller 120 is supplied with a vertical/horizontal synchronization signals, and generates the timing control signals CTRX, CTRY and CTRZ necessary to drive the drivers 122,123 and 124, respectively, using the synchronization signals and the main clock.

As described above, the plasma display and the driving method thereof according to the present invention selects the on-cells with a low data voltage such as zero(0) V or ground voltage GND and selects the off-cells which do not occur the address discharge with a high data voltage. As a result, according to the present invention of the plasma display and the driving method thereof, power consumption is lowered because voltage applied to the data electrodes in the address discharge is minimized and power consumption is further lowered because the address discharge does not occur in the off-cells to which a relatively high voltage is applied and there is no current generated accordingly. Furthermore, according to the present invention of the plasma display and the driving method thereof, it is possible to minimize the heat generated in the data driving integrated circuit and to enhance the driving reliability by lowering the voltage needed to the address discharge and the current generated at the address discharge.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A plasma display having an address electrode, a scan electrode and a sustain electrode, wherein cells are arranged at the intersection of the electrodes, including:
an initializing driver for initializing the cells; and
an address driver for selecting on-cells by applying data of a first voltage to the address electrode and a scan pulse of a second voltage to the scan electrode, and for selecting off-cells by applying data of a third voltage and the scan pulse to the scan electrodes, wherein the third voltage is higher than the first voltage.

2. The plasma display of claim 1, wherein the initializing driver supplies an identical waveform to both of the scan electrode and the sustain electrode.

3. The plasma display of claim 2, wherein the initializing driver simultaneously supplies a rising ramp waveform and a falling ramp waveform following the rising ramp waveform to the scan electrode and the sustain electrode.

4. The plasma display of claim 3, wherein the initializing driver supplies the falling ramp waveform and a rising ramp waveform following the falling ramp waveform to the scan electrode, and supplies a fourth negative voltage to the sustain electrode.

5. The plasma display of claim 4, wherein the plasma display further includes a sustain driver for supplying the fourth voltage to the sustain electrode in the address period to select the on-cells and the off-cells.

6. The plasma display of claim 3 or claim 4, wherein the falling ramp waveform falls from a first negative voltage to a second negative voltage, the absolute value of the second negative voltage being higher than that of the first negative voltage; and wherein the rising ramp waveform rises from the first negative voltage to zero(0)V.

7. The plasma display of claim 1, wherein the first voltage to select the on-cells is any one of zero(0)V and the ground voltage GND; and wherein the second voltage is a positive voltage.

8. The plasma display of claim 1, wherein the plasma display further includes a sustain driver for applying alternately a sustain pulse of a fifth voltage to the scan electrode and the sustain electrode to occur a sustain discharge with respect to the on-cells.

9. A method of driving a plasma display having an address electrode, a scan electrode and a sustain electrode, wherein cells are arranged at the intersection of the electrodes, comprising:
initializing the cells;
selecting on-cells by applying data of a first voltage to the address electrode and a scan pulse of a second voltage to the scan electrode; and
selecting off-cells by applying data of a third voltage to the address electrode and the scan pulse to the scan electrode, wherein the second voltage is higher than the first voltage.

10. The method of claim 9, wherein the step of initializing the cells includes supplying an identical waveform to both of the scan electrode and the sustain electrode to make wall charges having an identical polarity accumulated on the scan electrode and the sustain electrode.

11. The method of claim 10, wherein the step of initializing the cells includes supplying simultaneously a rising ramp waveform and a falling ramp waveform following the rising ramp waveform to the scan electrode and the sustain electrode.

12. The method of claim 10, wherein the step of initializing the cells includes:
supplying a falling ramp waveform and a rising ramp waveform following the falling ramp waveform to the scan electrode; and
supplying a fourth negative voltage synchronized with the rising ramp waveform to the sustain electrode.

13. The method of claim 9, wherein the method further includes supplying the fourth voltage to the sustain electrode to select the on-cells and the off-cells, in the address period.

14. The method of claim 11 or claim 12, wherein the falling ramp waveform falls from a first negative voltage to a second negative voltage, the absolute value of the second negative voltage being higher than that of the first negative voltage and wherein the rising ramp waveform rises from the first negative voltage to zero(0)V.

15. The method of claim 9, wherein the first voltage to select the on-cells is any one of zero(0)V and the ground voltage GND; and wherein the second voltage is a positive voltage.

16. The method of claim 9, the method further includes applying alternately a sustain pulse of a fifth voltage to the scan electrode and the sustain electrode to occur a sustain discharge with respect to the on-cells.

17. A driving method of a plasma display, including:
a reset period for initializing cells;
an address period for selecting the cells using a scan voltage of a first polarity and a data voltage of a second polarity; and
a sustain period for maintaining a discharge of the cells using the sustain voltage of the first polarity.

18. The method of claim 17, wherein the cells are initialized by an initializing voltage of the first polarity in the reset period.
